(19) United States
(12) Patent Application Publication
(10) Pub. No.: US 2026/0178102 A1
(43) Pub. Date: Jun. 25, 2026

(54) ELECTRONIC DEVICE AND CONTROL METHOD THEREOF

(71) Applicant: NUVOTON TECHNOLOGY CORPORATION, HSINCHU CITY (TW)

(72) Inventor: Cheng-Chieh Wang, Zhubei City (TW)

(21) Appl. No.: 19/413,569

(22) Filed: Dec. 9, 2025

(30) Foreign Application Priority Data
Dec. 19, 2024 (TW) 113149521

(51) Int. Cl. G06F 1/3234; G06F 9/30

(52) U.S. Cl. CPC G06F 1/3243; G06F 9/30065; G06F 9/30123

(57) ABSTRACT

An electronic device is disclosed. The device includes a storage module configured to store a plurality of instructions, a controller configured to load and parse a first instruction, and a timing module. When the first instruction is a logic instruction, the controller selects and parses a second instruction according to the first instruction. When the first instruction is a trigger instruction, the controller outputs a first signal indicating a time period and a second signal indicating a peripheral module. The timing module receives the signals, counts to obtain a count value associated with the time period, compares the count value with the time period to generate a time trigger signal, and outputs a target trigger signal to trigger the peripheral module to operate.

### CROSS-REFERENCE TO RELATED APPLICATION

This application claims the priority benefit of Taiwan application serial no. 113149521, filed Dec. 19, 2024, the full disclosure of which is incorporated herein by reference.

### BACKGROUND

### Technical Field

The present disclosure relates to power-consumption control technologies, and more particularly to an electronic device and a control method thereof.

### Description of Related Art

In a low-power mode of a system, a central processing unit (CPU) typically enters an idle state in order to significantly reduce power consumption. Under such circumstances, when a peripheral module requires operation, a low-power timer is commonly used as a trigger source to wake up and drive the peripheral module.

Accordingly, how to operate a peripheral module effectively while maintaining low power consumption remains an issue to be addressed.

### SUMMARY

The present disclosure provides an electronic device and a control method thereof to address the issues described above.

In one embodiment of this disclosure, the electronic device includes a storage module configured to store a plurality of instructions. The electronic device also includes a controller electrically coupled to the storage module. The controller loads and parses a first instruction of the plurality of instructions. When a first type of the first instruction is a logic instruction, the controller selects a second instruction according to the first instruction. The controller then loads and parses the second instruction. When the first type of the first instruction is a trigger instruction, the controller outputs a first signal indicating a time period and a second signal indicating a peripheral module. The electronic device further includes a timing module electrically coupled to the storage module, the controller, and the peripheral module. The timing module receives the first signal and the second signal. The timing module counts to obtain a count value associated with the time period. The timing module compares the count value with the time period to generate a time trigger signal. Based on the time trigger signal, the timing module outputs a target trigger signal to trigger the peripheral module to operate.

In another embodiment of this disclosure, a control method for the electronic device is provided. The electronic device comprises a controller and a timing module. The control method includes loading and parsing, by the controller, a first instruction of a plurality of instructions. The control method further includes determining, by the controller, whether a first type of the first instruction is a logic instruction or a trigger instruction. When the first type is the logic instruction, the controller selects a second instruction according to the first instruction and loads and parses the second instruction. When the first type is the trigger instruction, the controller outputs the first signal indicating the time period and the second signal indicating the peripheral module. The timing module receives the first signal and the second signal. The timing module counts to obtain the count value associated with the time period. The timing module compares the count value with the time period to generate the time trigger signal. The timing module outputs the target trigger signal according to the time trigger signal to trigger the peripheral module to operate.

Based on the foregoing, the electronic device and the control method of the electronic device may reduce, or eliminate, a need for waking up a central processing unit to operate a peripheral module for performing more complex operations.

### BRIEF DESCRIPTION OF THE DRAWINGS

The drawings provided in the present disclosure enable a person having ordinary skill in the technical field of the present disclosure to further understand the present disclosure. The drawings are incorporated in and constitute a part of the description of the present disclosure. The drawings illustrate exemplary embodiments of the present disclosure and are used together with the description of the present disclosure to explain principles of the present disclosure.

FIG. 1 is a block diagram illustrating an electronic device according to an embodiment of the present disclosure.

FIG. 2 is a block diagram illustrating a controller of the electronic device according to an embodiment of the present disclosure.

FIG. 3 is a block diagram illustrating a timing module of the electronic device according to an embodiment of the present disclosure.

FIG. 4 is a schematic diagram illustrating stored instructions of the electronic device according to an embodiment of the present disclosure.

FIG. 5 is a schematic diagram illustrating operations of a peripheral module triggered by the electronic device according to an embodiment of the present disclosure.

FIG. 6 is a flowchart illustrating a control method applicable to the electronic device according to an embodiment of the present disclosure.

### DETAILED DESCRIPTION

The present disclosure provides an electronic device and a control method for the electronic device to address issues described in the background art. To make features of the present disclosure clearer, exemplary embodiments of the present disclosure are described below with reference to the drawings. The following description includes specific information related to the exemplary embodiments of the present disclosure. The drawings and the accompanying detailed description of the present disclosure illustrate exemplary embodiments of the present disclosure. The present disclosure is not limited to the exemplary embodiments. A person having ordinary skill in the technical field of the present disclosure may conceive other variations and embodiments of the present disclosure. Unless stated otherwise, identical or corresponding elements in the drawings are denoted by identical or corresponding reference numerals. The drawings of the present disclosure are not necessarily drawn to scale and are not intended to represent actual relative dimensions.

The disclosure below provides multiple embodiments and examples for implementing different features of the present disclosure. The disclosure below describes specific examples of various components and arrangements of the components to simplify the explanation. These specific examples are not intended to limit the present disclosure. For example, when an embodiment of the present disclosure describes a first feature component being formed on or above a second feature component, the description may include embodiments in which the first feature component is in direct contact with the second feature component. The description may also include embodiments in which an additional feature component is formed between the first feature component and the second feature component, such that the first feature component and the second feature component are not in direct contact.

Additional operational steps may be performed before, between, or after the steps of the method described in the present disclosure. In other embodiments of the method described in the present disclosure, some operational steps may be replaced or omitted.

Spatial terms may be used in the present disclosure, including “below,” “under,” “lower,” “above,” “over,” “upper,” and similar terms. These spatial terms are used for convenience to describe relationships between one or more components or feature elements and one or more other components or feature elements in the drawings. These spatial terms include different orientations of an apparatus during use or operation, as well as orientations illustrated in the drawings. When an apparatus is rotated to another orientation, such as by 90 degrees or another angle, interpretations of the spatial terms used in the present disclosure follow the rotated orientation.

In the description of the present disclosure, the terms “about,” “approximately,” and “roughly” generally indicate a range within 20%, 10%, 5%, 3%, 2%, 1%, or 0.5% of a given value or range. The given value is therefore an approximate value. Accordingly, when the terms “about,” “approximately,” or “roughly” are used without further specification, the terms inherently include the meaning described above.

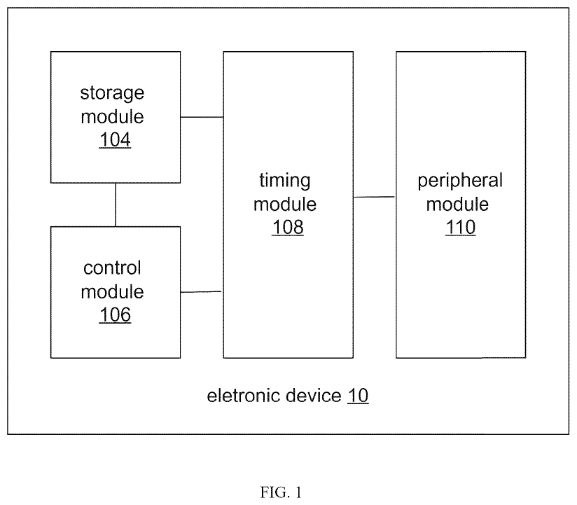

FIG. 1 is a block diagram illustrating an electronic device according to an embodiment of the present disclosure. Referring to FIG. 1, an electronic device 10 (also referred to as an element or a circuit) includes a storage module 104, a controller 106, and a timing module 108. The storage module 104 is configured to store a plurality of instructions. The controller 106 is electrically coupled to the storage module 104. The controller 106 loads and parses a first instruction of the plurality of instructions. When a first type of the first instruction is a logic instruction, the controller 106 selects a second instruction from the plurality of instructions according to the first instruction and loads and parses the second instruction. When the first type of the first instruction is a trigger instruction, the controller 106 outputs a first signal indicating a time period and a second signal indicating a peripheral module 110. The timing module 108 is electrically coupled to the storage module 104, the controller 106, and the peripheral module 110. The timing module 108 receives the first signal and the second signal. The timing module 108 counts to obtain a count value, wherein the count value is associated with the time period. The timing module 108 compares the count value with the time period to generate a time trigger signal. Based on the time trigger signal, the timing module 108 outputs a target trigger signal to trigger the peripheral module 110 to operate. For example, the electronic device 10 may be a portable device, such as a notebook computer or a tablet computer, or may be a desktop computer. The peripheral module 110 may include an input device such as a keyboard, a mouse, or a touchpad. But this disclosure is not limited thereto.

In some embodiments, the storage module 104, the controller 106, and the timing module 108 may be integrated into a processing element or module, or into a timing element or module.

The electronic device 10 may further include a central processing unit (CPU) that is not illustrated in the drawings. The central processing unit is electrically coupled to the storage module 104. The central processing unit is also electrically coupled to the timing module 108. In some embodiments, when the central processing unit is in an idle state or a power-saving state, the controller 106, such as a specific module included in the controller 106, performs operations.

In some embodiments, the logic instruction is associated with at least one of a loop function, a delay function, and a stop function, but the disclosure is not limited thereto. In some embodiments, the loop function is associated with at least one of a loop start and a loop count.

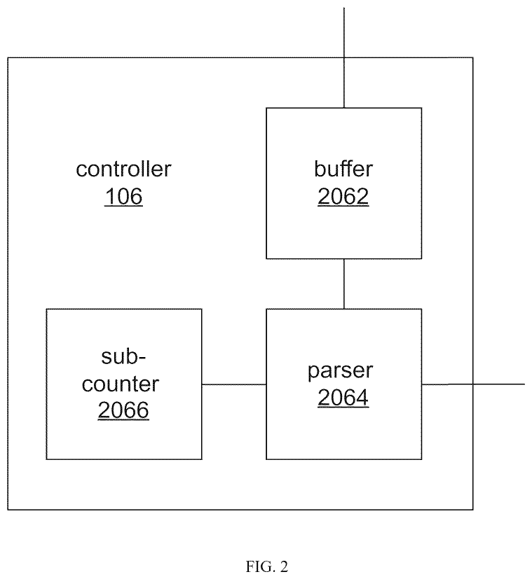

FIG. 2 is a block diagram illustrating the controller 106 of the electronic device 10 according to an embodiment of the present disclosure. Referring to FIG. 2, the controller 106 includes a buffer 2062 and a parser 2064. The buffer 2062 is electrically coupled to the storage module 104 and is configured to load and store the plurality of instructions from the storage module 104, for example, sequentially. The parser 2064 is electrically coupled to the buffer 2062. The parser 2064 loads and parses the first instruction from the buffer 2062. When the first type of the first instruction is the logic instruction, the parser 2064 selects the second instruction according to the first instruction and loads and parses the second instruction from the buffer 2062. When the first type of the first instruction is the trigger instruction, the parser 2064 outputs the first signal and the second signal.

In some embodiments, the controller 106 may further include a sub-counter 2066. The sub-counter 2066 counts a sub-count value. The sub-count value is associated with a loop count. In some embodiments, when the first type of the first instruction is the logic instruction, an operation of selecting the second instruction according to the first instruction includes the parser 2064 selecting, from the plurality of instructions, the second instruction according to whether the sub-count value has reached the loop count, when the first instruction is associated with the loop count. In some embodiments, when the first instruction is associated with a loop function, the sub-counter 2066 counts the sub-count value.

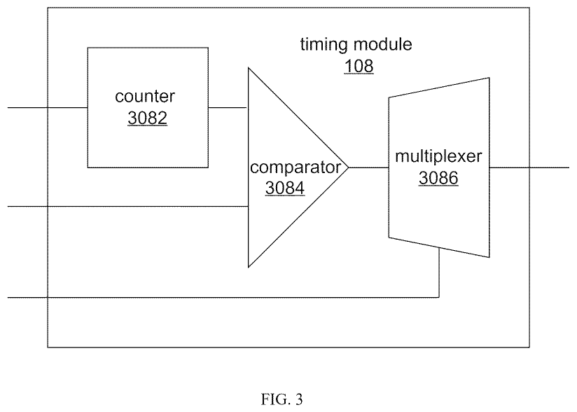

FIG. 3 is a block diagram illustrating the timing module 108 of the electronic device 10 according to an embodiment of the present disclosure. Referring to FIG. 3, the timing module 108 includes a counter 3082, a comparator 3084, and a multiplexer 3086. The counter 3082 may be electrically coupled to the storage module 104 and the controller 106. The counter 3082 counts to obtain the count value. A first input terminal of the comparator 3084 is electrically coupled to the counter 3082, and a second input terminal of the comparator 3084 is electrically coupled to the controller 106. The comparator 3084 receives the count value from the counter 3082. The comparator 3084 receives the first signal indicating the time period from the controller 106. The comparator 3084 compares the count value with the time period to generate and output the time trigger signal. An input terminal of the multiplexer 3086 may be electrically coupled to an output terminal of the comparator 3084. A control terminal of the multiplexer 3086 may be electrically coupled to the controller 106. An output terminal of the multiplexer 3086 is electrically coupled to the peripheral module 110. The multiplexer 3086 receives the second signal indicating the peripheral module 110 from the controller 106. The multiplexer 3086 receives the time trigger signal from the comparator 3084. Based on the time trigger signal, the multiplexer 3086 outputs the target trigger signal to trigger the peripheral module 110 to operate.

In some embodiments, the storage module 104 may include at least one of a memory and a register. However, the present disclosure is not limited thereto. The memory may be a non-volatile memory (NVM).

In some embodiments, when the central processing unit 102 is in a performance state, the storage module 104 may store the plurality of instructions. Specifically, the plurality of instructions and data may be input or written into the storage module 104 through control of the central processing unit 102. For example, a user may sequentially input the plurality of instructions into the register.

In some embodiments, the time period may be defined in units of clock cycles. However, the present disclosure is not limited thereto.

In some embodiments, an operation of outputting the target trigger signal according to the time trigger signal may include outputting the target trigger signal in response to receiving the time trigger signal.

In some embodiments, the electronic device 10 may further include the peripheral module 110.

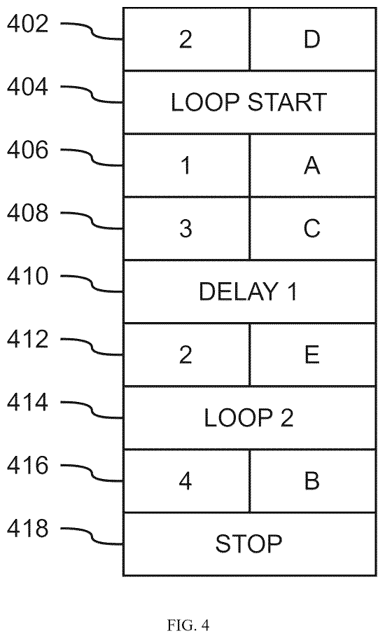

FIG. 4 is a schematic diagram illustrating stored instructions according to an embodiment of the present disclosure. Referring to FIG. 4, an instruction 402 is a trigger instruction indicating that a peripheral module D is triggered after two counts. An instruction 404 is a logic instruction indicating a loop start (that is, LOOP START). An instruction 406 is a trigger instruction indicating that a peripheral module A is triggered after one count. An instruction 408 is a trigger instruction indicating that a peripheral module C is triggered after three counts. An instruction 410 is a logic instruction indicating a delay of one count. An instruction 412 is a trigger instruction indicating that a peripheral module E is triggered after two counts. An instruction 414 is a logic instruction indicating a loop count of two (that is, LOOP 2). An instruction 416 is a trigger instruction indicating that a peripheral module B is triggered after four counts. An instruction 418 is a logic instruction indicating a stop operation.

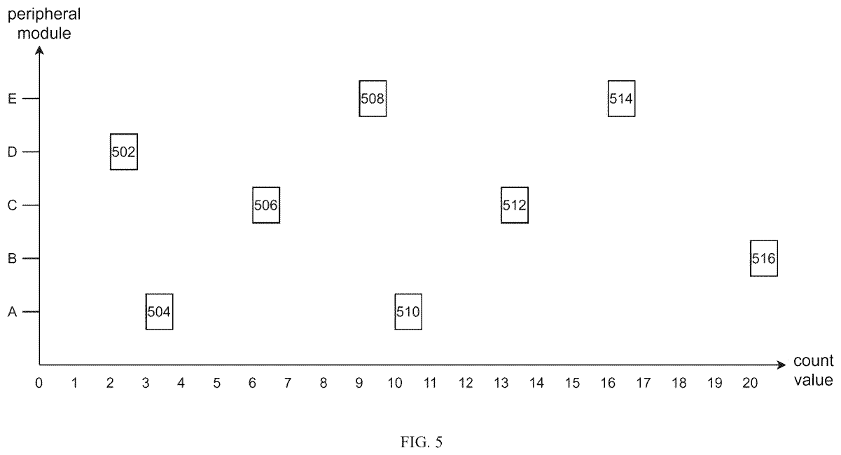

FIG. 5 is a schematic diagram illustrating operations of triggered peripheral modules according to an embodiment of the present disclosure. A horizontal axis represents count values of the counter. A vertical axis represents peripheral modules. Target trigger signals 502, 504, 506, 508, 510, and 512 represent time points at which trigger events occur.

Referring to FIG. 4 and FIG. 5, the buffer stores, in sequence, the instructions 402, 404, 406, 408, 410, 412, 414, 416, and 418.

When the instruction 402 is processed, the peripheral module D is selected. The comparator 3084 is set to a value of two (=0+2). The counter 3082 starts counting. When the count value reaches two, a target trigger signal 502 is sent to the peripheral module D.

When the instruction 404 is processed, a loop is started. The instructions inside the loop may be processed through another buffer. At this time, the loop has two remaining iterations, and the sub-count value is zero.

When the instruction 406 is processed through the buffer or the other buffer, the peripheral module A is selected. The comparator 3084 is set to a value of three (=2+1). The counter 3082 starts counting. When the count value reaches three, a target trigger signal 504 is sent to the peripheral module A.

When the instruction 408 is processed through the buffer or the other buffer, the peripheral module C is selected. The comparator 3084 is set to a value of six (=3+3). The counter 3082 starts counting. When the count value reaches six, a target trigger signal 506 is sent to the peripheral module C.

When the instruction 410 is processed through the buffer or the other buffer, one count is delayed, and no event is output.

When the instruction 412 is processed through the buffer or the other buffer, the peripheral module E is selected. The comparator 3084 is set to a value of nine (=7+2). The counter 3082 starts counting. When the count value reaches nine, a target trigger signal 508 is sent to the peripheral module E.

When the instruction 414 is processed through the buffer or the other buffer, one loop iteration remains and the sub-count value is one. Therefore, the instructions inside the loop, namely the instructions 406, 408, 410, and 412, are repeatedly processed.

After the instructions 406, 408, 410, and 412 are sequentially processed through the buffer or the other buffer, zero loop iterations remain and the sub-count value is two. The loop is completed, and processing through the buffer or the other buffer is exited.

When the instruction 416 is processed, the peripheral module B is selected. The comparator 3084 is set to a value of twenty (=16+4). The counter 3082 starts counting. When the count value reaches twenty, a target trigger signal 516 is sent to the peripheral module B.

When the instruction 418 is processed, the process is ended, the hardware count is reset, and new instructions are awaited.

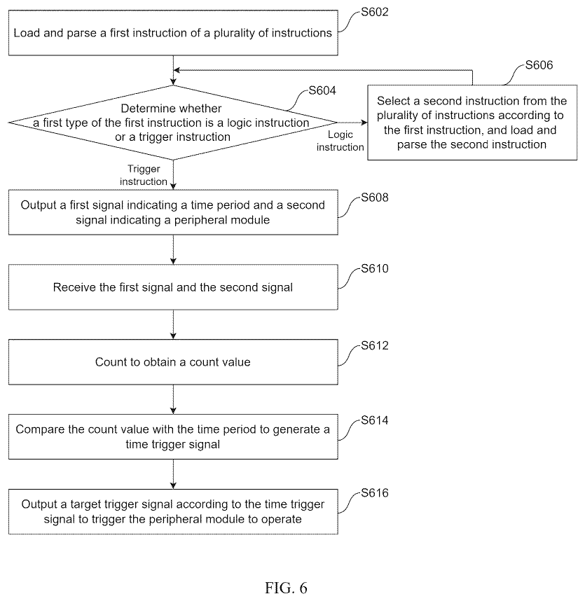

According to the embodiments described above, the following control method may be obtained, for example, by summarizing the embodiments. FIG. 6 is a flowchart illustrating a control method according to an embodiment of the present disclosure. The control method is applicable to an electronic device, and the electronic device includes a controller and a timing module. The control method includes the following steps.

In step S602, the controller loads and parses a first instruction of a plurality of instructions, and step S604 is then performed.

In step S604, the controller determines whether a first type of the first instruction is a logic instruction or a trigger instruction. When the first type is the logic instruction, step S606 is performed. When the first type is the trigger instruction, step S608 is performed.

In step S606, the controller selects a second instruction from the plurality of instructions according to the first instruction and loads and parses the second instruction, and step S604 is then performed.

In step S608, the controller outputs a first signal indicating a time period and a second signal indicating a peripheral module, and step S610 is then performed.

In step S610, the timing module receives the first signal and the second signal, and step S612 is then performed.

In step S612, the timing module counts to obtain a count value, wherein the count value is associated with the time period, and step S614 is then performed.

In step S614, the timing module compares the count value with the time period to generate a time trigger signal, and step S616 is then performed.

In step S616, the timing module outputs a target trigger signal according to the time trigger signal to trigger the peripheral module to operate.

Based on the foregoing, the electronic device and the control method of the electronic device may reduce, or eliminate, a need for waking up a central processing unit to operate a peripheral module for performing more complex operations, thereby achieving reduced power consumption.

Although the present application has been disclosed through the embodiments described above, the embodiments are not intended to limit the present disclosure. Any modifications and variations to the embodiments described above that are made by a person having ordinary skill in the technical field of the present disclosure without departing from the spirit and scope of the present disclosure fall within the technical scope protected by the present disclosure. Therefore, a scope of protection of the present disclosure shall be defined by the claims.

What is claimed is:

1. An electronic device, comprising:
a storage module configured to store a plurality of instructions;
a controller electrically coupled to the storage module and configured to:
load and parse a first instruction of the plurality of instructions;
when a first type of the first instruction is a logic instruction, select a second instruction from the plurality of instructions according to the first instruction, and load and parse the second instruction; and
when the first type is a trigger instruction, output a first signal indicating a time period and a second signal indicating a peripheral module; and
a timing module electrically coupled to the storage module, the controller, and the peripheral module, and configured to:
receive the first signal and the second signal;
count to obtain a count value, wherein the count value is associated with the time period;
compare the count value with the time period to generate a time trigger signal;
and output a target trigger signal to trigger the peripheral module to operate according to the time trigger signal.

2. The electronic device of claim 1, wherein when a central processing unit of the electronic device is in an idle state or a power-saving state, the controller performs operations.

3. The electronic device of claim 1, wherein the logic instruction is associated with at least one of a loop function, a delay function, and a stop function.

4. The electronic device of claim 1, wherein the controller comprises:
a buffer electrically coupled to the storage module and configured to load and store the plurality of instructions from the storage module; and
a parser electrically coupled to the buffer and configured to:
load and parse the first instruction from the buffer;
select the second instruction according to the first instruction, and load and parse the second instruction from the buffer when the first type is the logic instruction; and
output the first signal and the second signal when the first type is the trigger instruction.

5. The electronic device of claim 4, wherein the controller further comprises a sub-counter electrically coupled to the parser and configured to count a sub-count value, wherein the sub-count value is associated with a loop count.

6. The electronic device of claim 5, wherein when the first type is the logic instruction, selecting the second instruction according to the first instruction comprises:
selecting, by the parser, the second instruction from the plurality of instructions according to whether the sub-count value has reached the loop count when the first type is the logic instruction and the first instruction is associated with the loop count.

7. The electronic device of claim 1, wherein the timing module comprises:
a counter electrically coupled to the storage module and the controller, and configured to count to obtain the count value;
a comparator having a first input terminal electrically coupled to the counter and a second input terminal electrically coupled to the controller, and configured to:
receive the count value from the counter;
receive the first signal indicating the time period from the controller; and
compare the count value with the time period to generate and output the time trigger signal; and
a multiplexer having an input terminal electrically coupled to an output terminal of the comparator, a control terminal electrically coupled to the controller, and an output terminal electrically coupled to the peripheral module, and configured to:
receive the second signal indicating the peripheral module from the controller;
receive the time trigger signal from the comparator; and
output the target trigger signal to trigger the peripheral module to operate according to the time trigger signal.

8. The electronic device of claim 7, wherein outputting the target trigger signal according to the time trigger signal comprises:
outputting the target trigger signal via the multiplexer and in response to receiving the time trigger signal from the comparator.

9. A control method applied to an electronic device, wherein the electronic device comprises a controller and a timing module, the control method comprising:
loading and parsing, via the controller, a first instruction of a plurality of instructions;
determining, via the controller, whether a first type of the first instruction is a logic instruction or a trigger instruction;
selecting, via the controller, a second instruction from the plurality of instructions according to the first instruction, and loading and parsing the second instruction when the first type is the logic instruction;
outputting, via the controller, a first signal indicating a time period and a second signal indicating a peripheral module when the first type is the trigger instruction;
receiving, via the timing module, the first signal and the second signal;
counting, via the timing module, to obtain a count value, wherein the count value is associated with the time period;
comparing, via the timing module, the count value with the time period to generate a time trigger signal; and
outputting, via the timing module and according to the time trigger signal, a target trigger signal to trigger the peripheral module to operate.

10. The control method of claim 9, wherein when a central processing unit of the electronic device is in an idle state or a power-saving state, operations are performed via the controller.
